(19) United States
(12) Patent Application Publication
(10) Pub. No.: US 2026/0073864 A1
(43) Pub. Date: Mar. 12, 2026

(54) DISPLAY DEVICE, VOLTAGE SETTING METHOD OF DISPLAY DEVICE, AND ELECTRONIC DEVICE

(71) Applicant: Samsung Display Co., LTD., Yongin-si (KR)

(72) Inventors: Sung Jin KIM, Yongin-si (KR); Young Uk HWANG, Yongin-si (KR); Sang Hyuk SHIM, Yongin-si (KR); Seung Hyuk LEE, Yongin-si (KR); Hyeon Deok JO, Yongin-si (KR)

(73) Assignee: Samsung Display Co., LTD., Yongin-si (KR)

(21) Appl. No.: 19/175,302

(22) Filed: Apr. 10, 2025

(30) Foreign Application Priority Data
Sep. 10, 2024 (KR) 10-2024-0123189

(51) Int. Cl. G09G 3/3233; G09G 3/00; G09G 3/32

(52) U.S. Cl. CPC G09G 3/3233; G09G 3/006; G09G 3/32; G09G 2300/0819; G09G 2300/0842; G09G 2300/0861; G09G 2310/0286; G09G 2310/08; G09G 2320/0242; G09G 2340/0435; G09G 2360/16

(57) ABSTRACT

A voltage setting method of a display device includes setting a first power voltage provided to a cathode of a light emitting element of each of pixels, setting a difference value between an anode initialization voltage provided to an anode of the light emitting element and the first power voltage so that a luminance change according to a frequency change is minimized, and resetting the difference value so that a color change according to the frequency change is minimized.

### CROSS REFERENCE TO RELATED APPLICATION(S)

This application claims priority to and benefits of Korean Patent Application No. 10-2024-0123189 under 35 U.S.C. § 119, filed on Sep. 10, 2024, in the Korean Intellectual Property Office (KIPO), the entire contents of which are incorporated herein by reference.

### BACKGROUND

### 1. Technical Field

The disclosure relates to a display device, a voltage setting method of the display device, and an electronic device including the display device.

### 2. Description of the Related Art

A display device includes multiple pixels. Each of the pixels includes multiple transistors, a light emitting element electrically connected to the transistors, and a capacitor. The transistors are turned on in response to signals provided through a line, and thus a driving current is generated. The light emitting element emits light correspondingly to the driving current.

Recently, a method of driving a display device at a low frequency is used in order to improve driving efficiency of the display device and minimize power consumption.

### SUMMARY

The disclosure provides a display device and a voltage setting method of the display device capable of minimizing a luminance change and a color change during frequency change driving.

Objects of the disclosure are not limited to the object described above, and other technical objects which are not described may be clearly understood by those skilled in the art from the following description.

According to embodiments of the disclosure, a voltage setting method of a display device including pixels may include setting a first power voltage provided to a cathode of a light emitting element of each of pixels, setting a difference value between an anode initialization voltage provided to an anode of the light emitting element and the first power voltage so that a luminance change according to a frequency change is minimized, and resetting the difference value so that a color change according to the frequency change is minimized.

The pixels may include a first pixel, a second pixel, and a third pixel that emit light with different colors, and the setting of the difference value may include setting a second difference value for the first pixel and the second pixel and a third difference value for the third pixel by repeatedly testing temporary difference values for the first to third pixels.

The first pixel may emit light in red, the second pixel may emit light in green, and the third pixel may emit light in blue.

In the repeatedly testing of the temporary difference values for the first to third pixels, the temporary difference values for the first and second pixels and the temporary difference values for the third pixel may simultaneously change.

The setting of the difference value may include measuring a luminance of an image displayed at a first frequency, measuring a luminance of an image displayed at a second frequency, and determining the second and third difference values at which a difference between a measurement luminance at the first frequency and a measurement luminance at the second frequency is minimized.

The resetting of the difference value may include resetting the third difference value by repeatedly testing the temporary difference values for the third pixel in a state in which the second difference value is fixed.

The resetting of the difference value may further include measuring a color coordinate of an image displayed at a first frequency, measuring a color coordinate of an image displayed at a second frequency, and determining the third difference value at which a difference between a color difference measured at the first frequency and a color difference measured at the second frequency is minimized.

A second anode initialization voltage may be commonly provided as the anode initialization voltage to the first pixel and the second pixel, and a third anode initialization voltage independent of the second anode initialization voltage may be provided as the anode initialization voltage to the third pixel.

The resetting of the difference value may further include setting a first difference value for the first pixel by repeatedly testing temporary difference values for the first pixel in a state in which the second difference value and the third difference value are fixed.

The anode initialization voltage provided to each of the first pixel, the second pixel, and the third pixel may be different.

According to embodiments of the disclosure, a display device may include a display panel including pixels, in which each of the pixels includes a light emitting element, and the pixels include a first pixel, a second pixel, and a third pixel that emit light with different colors, a data driver that provides a data signal to the pixels, and a power supply that provides an anode initialization voltage to an anode of the light emitting element and provide a first power voltage to a cathode of the light emitting element. A frame may include an active period in which the data signal is written to the pixels to emit light, and a blank period in which the pixels cmit light without writing the data signal. The anode initialization voltage in the blank period and the anode initialization voltage in the active period may be different from each other. A change amount of the anode initialization voltage for the second pixel between the active period and the blank period and a change amount of the anode initialization voltage for the third pixel may be different from each other.

A change amount of the anode initialization voltage for the first pixel between the active period and the blank period and the change amount of the anode initialization voltage for the second pixel between the active period and the blank period may be equal.

A second anode initialization voltage may be commonly provided as the anode initialization voltage to the first pixel and the second pixel, and a third anode initialization voltage independent of the second anode initialization voltage may be provided as the anode initialization voltage to the third pixel.

The first pixel may emit light in red, the second pixel may emit light in green, and the third pixel may emit light in blue.

A change amount of the anode initialization voltage for the first pixel may be different from the change amount of the anode initialization voltage for the second pixel and the change amount of the anode initialization voltage for the third pixel.

The anode initialization voltage provided to each of the first pixel, the second pixel, and the third pixel may be different.

A difference value between the anode initialization voltage and the first power voltage in the blank period and a difference value between the anode initialization voltage and the first power voltage in the active period may be different from each other, and a difference value between the anode initialization voltage and the first power voltage for the second pixel between the active period and the blank period and a difference value between the anode initialization voltage and the first power voltage for the third pixel between the active period and the blank period may be different from each other.

A difference value between the anode initialization voltage and the first power voltage for the first pixel between the active period and the blank period and the difference value between the anode initialization voltage and the first power voltage for the second pixel between the active period and the blank period may be equal.

A difference value between the anode initialization voltage and the first power voltage for the first pixel between the active period and the blank period may be different from the difference value for the second pixel and the difference value for the third pixel.

According to embodiments of the disclosure, an electronic device may include a display panel including pixels, in which each of the pixels includes a light emitting element, and the pixels include a first pixel, a second pixel, and a third pixel that emit light with different colors, a data driver that provides a data signal to the pixels based on input image data, a processor that provides the input image data to the data driver, and a power supply that provides an anode initialization voltage to an anode of the light emitting element and a first power voltage to a cathode of the light emitting element. The anode initialization voltage may change according to a refresh rate. In case that the refresh rate changes, a change amount of the anode initialization voltage for the second pixel and a change amount of the anode initialization voltage for the third pixel may be different from each other.

Specific details of other embodiments are included in the detailed description and

### DRAWINGS

The display device and the voltage setting method of the display device according to embodiments of the disclosure may minimize not only a luminance change according to a frequency change but also a color change by individually setting a difference value between an anode initialization voltage and a first power voltage for each color, and may improve display quality.

An effect according to embodiments is not limited to the content exemplified above, and more various effects are included in the specification.

### BRIEF DESCRIPTION OF THE DRAWINGS

The above and other features of the disclosure will become more apparent by describing in further detail embodiments thereof with reference to the accompanying drawings, in which:

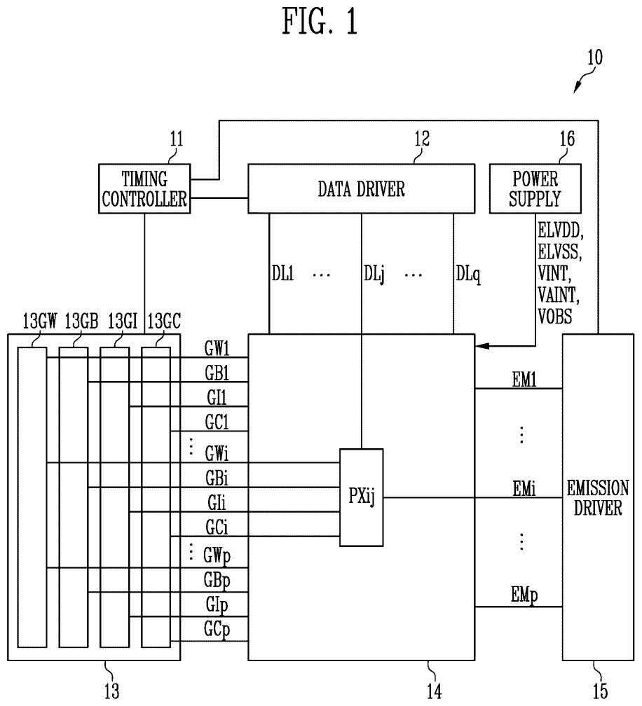

FIG. 1 is a schematic diagram illustrating a display device according to embodiments;

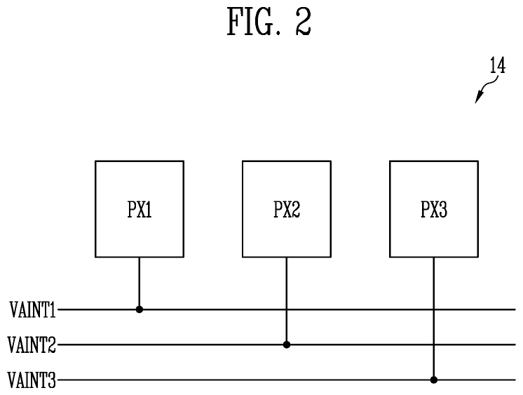

FIG. 2 is a schematic diagram illustrating an embodiment of a pixel unit included in the display device of FIG. 1;

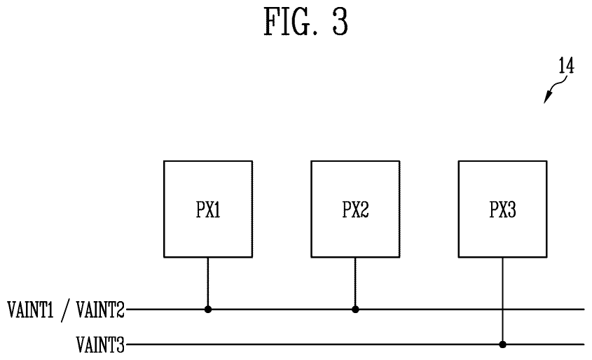

FIG. 3 is a schematic diagram illustrating an embodiment of a pixel unit included in the display device of FIG. 1;

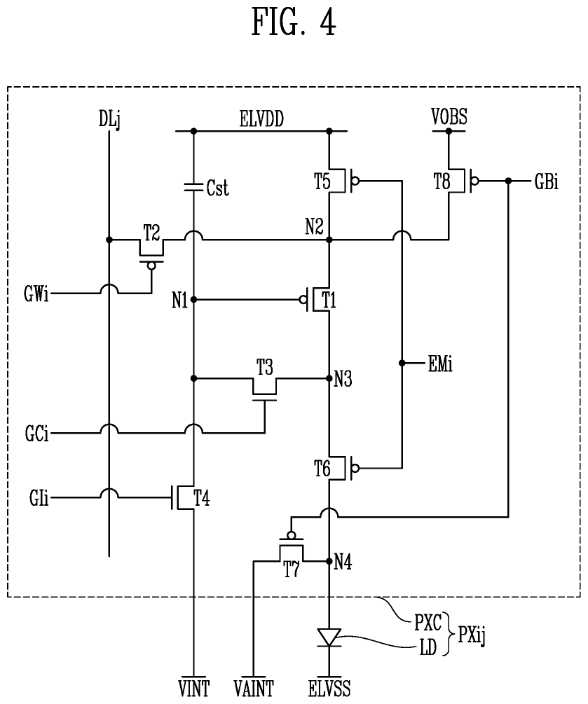

FIG. 4 is a schematic diagram of an equivalent circuit of a pixel included in the display device of FIG. 1 according to an embodiment;

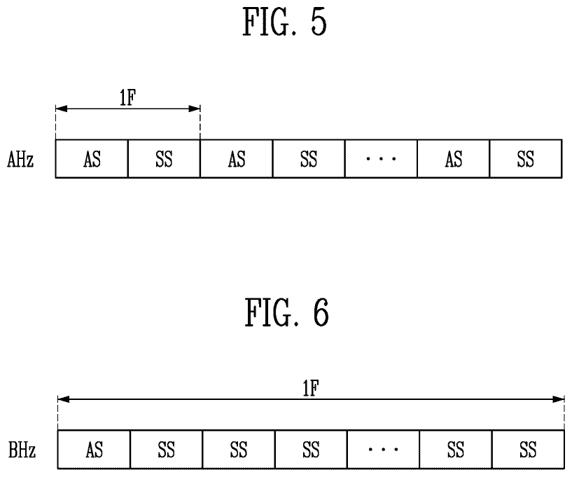

FIG. 5 is a schematic diagram illustrating a display frequency change according to an embodiment;

FIG. 6 is a schematic diagram illustrating a display frequency change according to an embodiment;

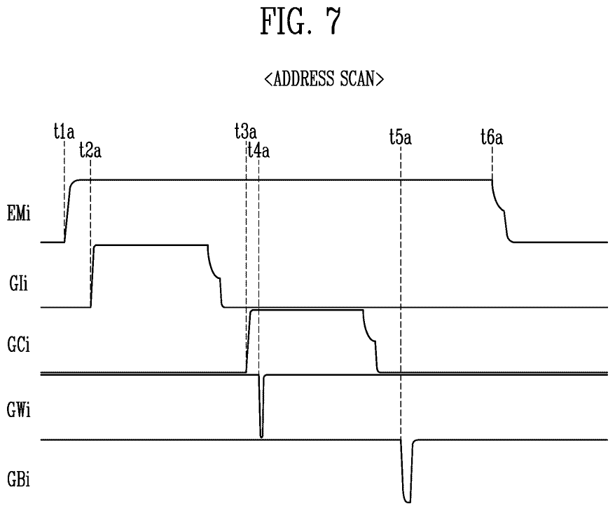

FIG. 7 is a graph illustrating an address scan period;

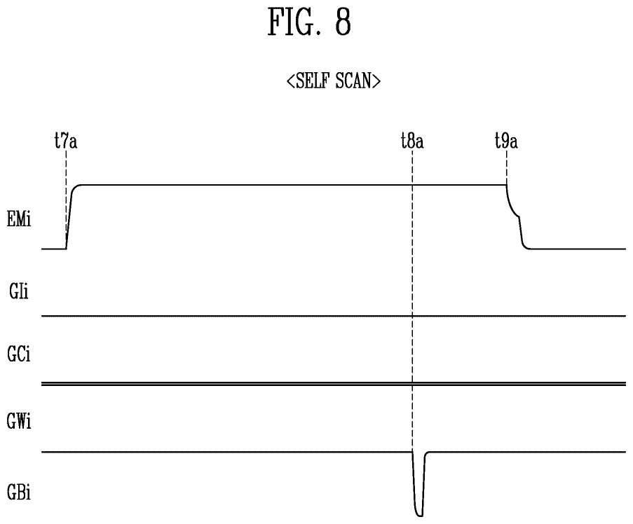

FIG. 8 is a graph illustrating a self scan period;

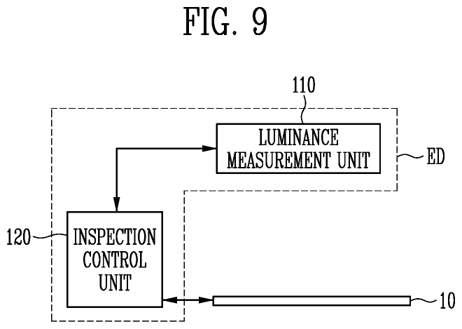

FIG. 9 is a schematic diagram illustrating a voltage setting device according to an embodiment;

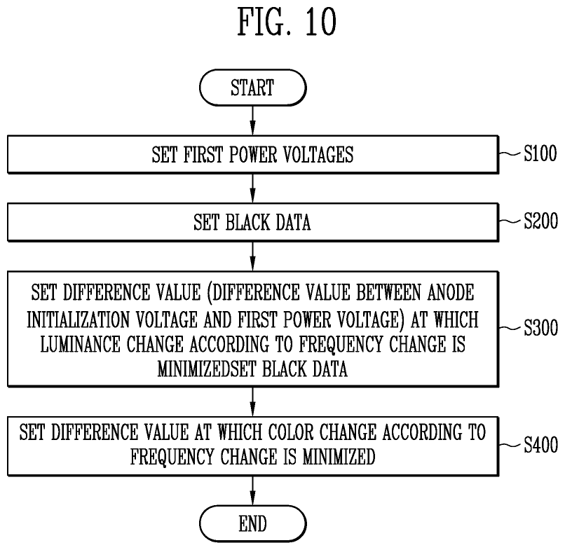

FIG. 10 is a flowchart illustrating a voltage setting method according to embodiments;

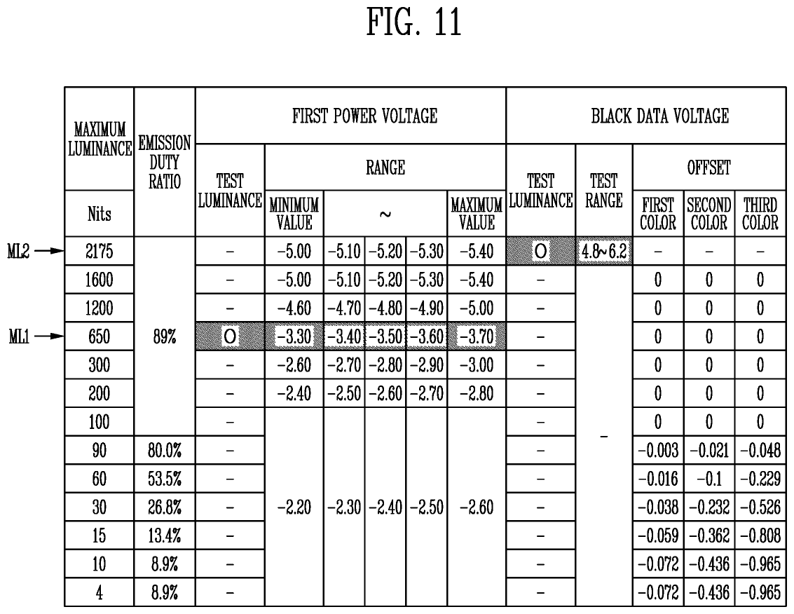

FIGS. 11 to 14 are tables illustrating the voltage setting method of FIG. 10;

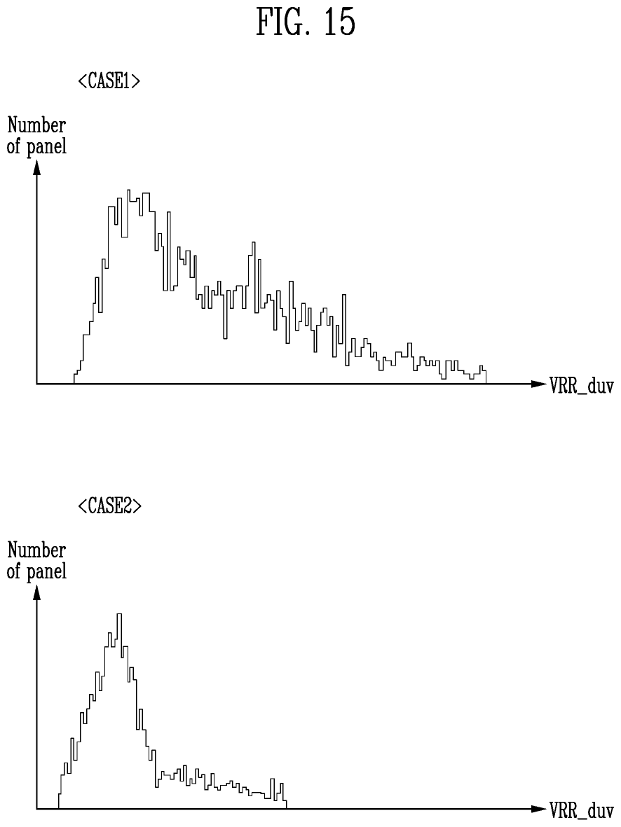

FIG. 15 shows graphs illustrating a color change of display devices; and

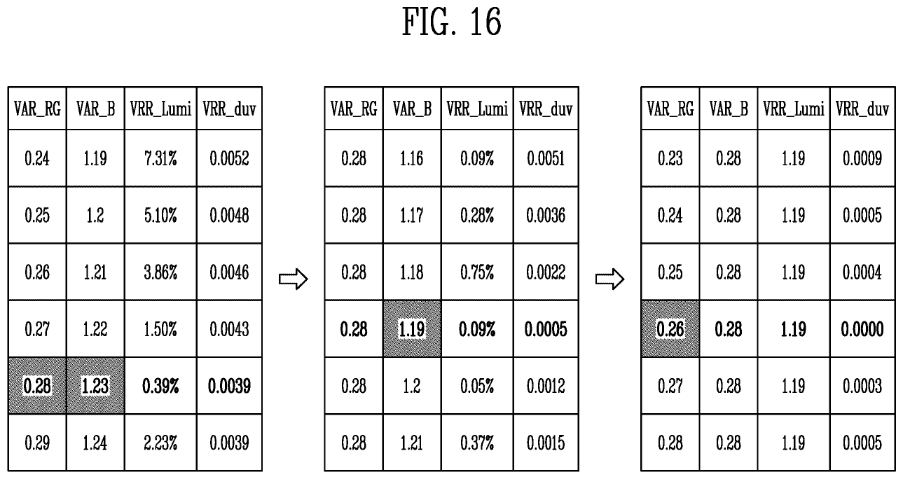

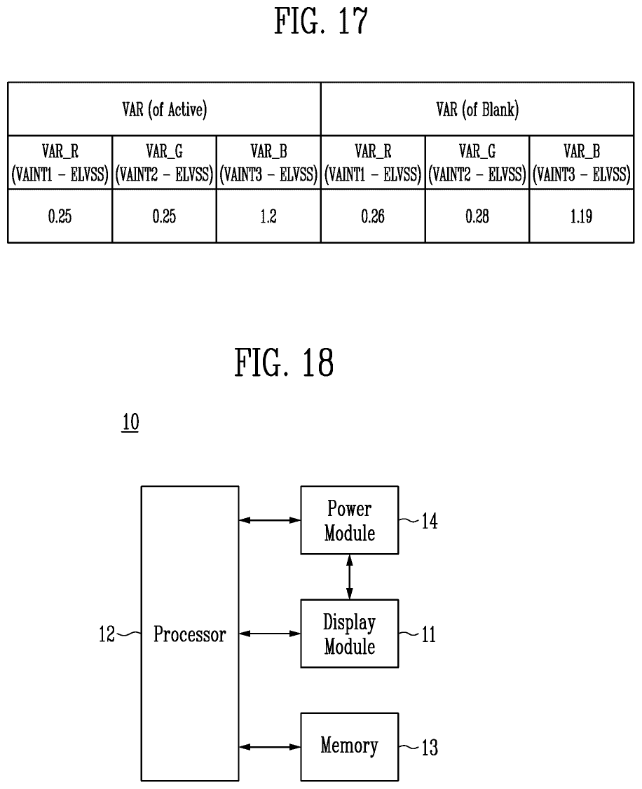

FIGS. 16 and 17 are tables illustrating a voltage setting method according to an embodiment.

FIG. 18 is a schematic block diagram of an electronic device according to an embodiment.

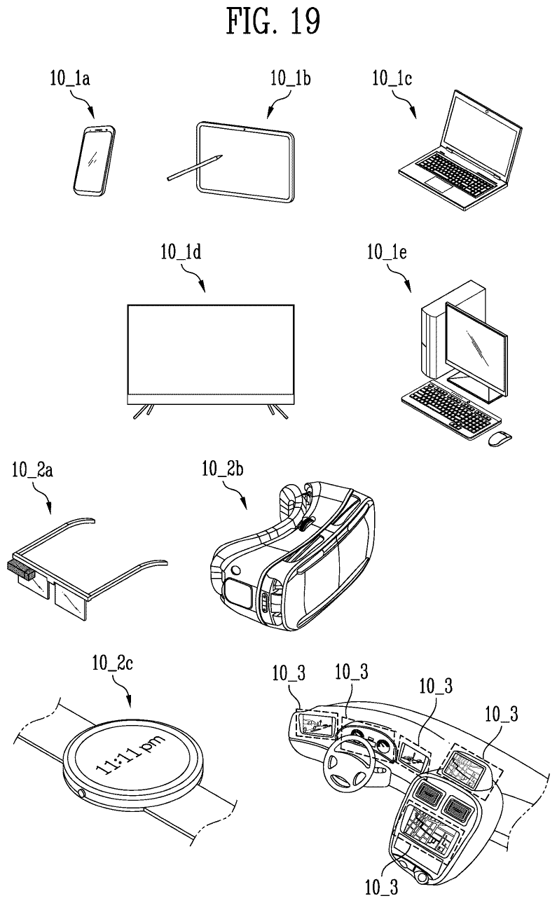

FIG. 19 shows schematic diagrams of various embodiments of an electronic device.

### DETAILED DESCRIPTION OF THE EMBODIMENT

Hereinafter, various embodiments of the disclosure will be described in detail with reference to the accompanying drawings so that those skilled in the art may readily carry out the disclosure. The disclosure may be implemented in various different forms and is not limited to the embodiments described herein.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals, reference characters, and/or reference symbols denote like elements.

In addition, an expression “is the same” in the description may mean “is substantially the same”. For example, the expression “is the same” may be the same enough for those of ordinary skill to understand that it is the same. Other expressions may also be expressions in which “substantially” is omitted.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Also, when an element is referred to as being “in contact” or “contacted” or the like to another element, the element may be in “electrical contact” or in “physical contact” with another element; or in “indirect contact” or in “direct contact” with another element.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

In the specification and the claims, the phrase “at least one of” is intended to include the meaning of “at least one selected from the group of” for the purpose of its meaning and interpretation. For example, “at least one of A and B” may be understood to mean “A, B, or A and B.” In the specification and the claims, the term “and/or” is intended to include any combination of the terms “and” and “or” for the purpose of its meaning and interpretation. For example, “A and/or B” may be understood to mean “A, B, or A and B.” The terms “and” and “or” may be used in the conjunctive or disjunctive sense and may be understood to be equivalent to “and/or.”

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

FIG. 1 is a schematic diagram illustrating a display device according to embodiments. FIGS. 2 and 3 are schematic diagrams illustrating an embodiment of a pixel unit included in the display device of FIG. 1.

Referring to FIG. 1, the display device 10 may include a timing controller 11, a data driver 12, a scan driver 13, a pixel unit 14 (or a display panel), an emission driver 15, and a power supply 16.

The timing controller 11 may receive grayscales for an input image (or an input frame). The grayscales may include a first color grayscale, a second color grayscale, and a third color grayscale. The first color grayscale may be a grayscale for expressing a first color, the second color grayscale may be a grayscale for expressing a second color, and the third color grayscale may be a grayscale for expressing a third color.

The timing controller 11 may also receive a control signal for an image. The control signal may include a horizontal synchronization signal (Hsync), a vertical synchronization signal (Vsync), and a data enable signal. A vertical synchronization signal may include multiple pulses, and may indicate that a previous frame period is ended and a current frame period is started based on a time point at which each of the pulses is generated. An interval between adjacent pulses of the vertical synchronization signal may correspond to one frame period. A horizontal synchronization signal may include multiple pulses, and may indicate that a previous horizontal period is ended and a new horizontal period is started based on a time point at which each of the pulses is generated. An interval between adjacent pulses of the horizontal synchronization signal may correspond to one horizontal period. A data enable signal may have an enable level during a horizontal period and a disable level during a remaining horizontal period. In case that the data enable signal is at the enable level, the data enable signal may indicate that color grayscales are supplied in a corresponding horizontal period.

The timing controller 11 may provide grayscales rendered or corrected to correspond to a specification of the display device 10 to the data driver 12. The timing controller 11 may also provide a clock signal, a scan start signal, and the like to the scan driver 13. The timing controller 11 may provide a clock signal, an emission stop signal, and the like to the emission driver 15.

The data driver 12 may generate data voltages to be provided to data lines DLI, . . . , DLj, . . . , and DLq using the grayscales and control signals received from the timing controller 11. The data driver 12 may sample the grayscales using the clock signal and apply the data voltages corresponding to the grayscales to the data lines in a pixel row unit. q may be an integer greater than 2, and j may be an integer greater than 1 and less than q.

A size of the data voltages may vary according to a corresponding grayscale. The data voltages may include a black data voltage. The black data voltage may be a data voltage that is required to be written to a pixel in case that the pixel displays a black image. For example, the black data voltage may correspond to a minimum grayscale (for example, 0 grayscale).

The size of the data voltages may vary according to a maximum luminance of the display device 10. The maximum luminance may be a luminance of light emitted from pixels set to a maximum grayscale (for example, 255 grayscales in case that grayscales are expressed in 8 bits). For example, the maximum luminance may be a luminance of white light generated in case that all pixels of the pixel unit 14 emit light to correspond to a white grayscale. A unit of a luminance may be nits. The maximum luminance may also be referred to as a display brightness value. The maximum luminance may be manually set by a user's operation of the display device 10, or may be automatically set by an algorithm linked to an illuminance sensor or the like. For example, a maximum value of the maximum luminance may be 2175 nits, and a minimum value may be 4 nits. The maximum value and the minimum value of the maximum luminance may be set variously according to a product. Even for a same grayscale, because the data voltage varies according to the maximum luminance, an emission luminance of the pixel may also vary.

The scan driver 13 may include first to fourth scan drivers 13GW, 13GB, 13GI, and 13GC. The first scan driver 13GW may provide first scan signals to first scan lines GW1, . . . , GWi, . . . , and GWp. p may be an integer greater than 2, and i may be an integer greater than 1 and less than p. The second scan driver 13 GB may provide second scan signals to second scan lines GB1, . . . , GBi, . . . , and GBp. The third scan driver 13GI may provide third scan signals to third scan lines GI1, . . . , Gli, . . . , and Glp. The fourth scan driver 13GC may provide fourth scan signals to fourth scan lines GC1, . . . , GCi, . . . , and GCp.

For example, the first scan driver 13GW may receive at least one scan clock signal and a scan start signal from the timing controller 11 to generate first scan signals to be provided to the first scan lines GW1 to GWp. The first scan driver 13GW may sequentially provide first scan signals having a turn-on level of pulse to the first scan lines GW1 to GWp. For example, the first scan driver 13GW may be configured in a shift register form, and may generate first scan signals in a method of sequentially transmitting a scan start signal which is a turn-on level of pulse form to a next scan stage under control of the scan clock signal.

Because each of the second scan driver 13 GB, the third scan driver 13GI, and the fourth scan driver 13GC may be configured similarly to the first scan driver 13GW, an overlapping description is omitted. According to an embodiment, at least some of the first to fourth scan drivers 13GW, 13 GB, 13GI, and 13GC may be integrated. For example, in case that a polarity and a width of a pulse are the same, two or more scan drivers may be integrated. For example, referring to FIG. 7 in advance, because a polarity and a width of a turn-on level of pulse applied to the third scan line GIi at a time point t2a and a turn-on level of pulse applied to fourth scan line GCi at a time point t3a are the same, the third scan driver 13GI and the fourth scan driver 13GC may be integrally configured.

The emission driver 15 may receive at least one emission clock signal and the emission stop signal from the timing controller 11 and generate emission signals to be provided to emission lines EM1, . . . , EMi, . . . , and EMp. The emission driver 15 may sequentially provide emission signals having a turn-off level of pulse to the emission lines EM1 to EMp. For example, the emission driver 15 may be configured in a shift register form, and may generate emission signals in a method of sequentially transmitting an emission stop signal which is a turn-off level of pulse form to a next emission stage according to control of an emission clock signal.

In FIG. 1, the number of each of the first scan lines GW1 to GWp, the second scan lines GB1 to GBp, the third scan lines GI1 to GIp, the fourth scan lines GC1 to GCp, and the emission lines EM1 to EMp are shown as p. However, the disclosure is not limited thereto, and in another embodiment, the number of at least one of the second scan lines GB1 to GBp, the third scan lines GI1 to GIp, the fourth scan lines GC1 to GCp, and the emission lines EM1 to EMp may be configured as p/2 or less. For example, two adjacent pixel rows may share one second scan line. Similarly, two adjacent pixel rows may share one third scan line, fourth scan line, or emission line. A same pixel row means pixels connected to a same first scan line.

The pixel unit 14 may include pixels. Each pixel PXij may be connected to corresponding data line DLj, scan lines GWi, GBi, Gli, and GCi, and emission line EMi. Each pixel PXij may include a light emitting element that emits light based on a received data voltage.

The pixel unit 14 may include first pixels PX1 (or a first sub-pixel) emitting light of a first color, second pixels PX2 (or a second sub-pixel) emitting light of a second color, and third pixels PX3 (or a third sub-pixel) emitting light of a third color. The first color, the second color, and the third color may be different colors. For example, the first color may be one of red, green, and blue, the second color may be another one of red, green, and blue, and the third color may be the other one of red, green, and blue. In another embodiment, magenta, cyan, and yellow may be used instead of red, green, and blue as the first to third colors. Hereinafter, for convenience of description, an embodiment that the first color is red, the second color is green, and the third color is blue will be described.

The pixel unit 14 may be arranged in various shapes such as diamond PENTILE™, RGB-Stripe, S-stripe, Real RGB, and normal PENTILE™.

The power supply 16 may provide voltages commonly supplied to the pixels of the pixel unit 14. For example, the power supply 16 may provide a first power voltage ELVSS, a second power voltage ELVDD, an initialization voltage VINT, an anode initialization voltage VAINT, and a bias voltage VOBS. For example, the power supply 16 may be a power management integrated circuit (PMIC). For example, the power supply 16 may be configured of multiple DC-DC converters.

The power supply 16 may provide anode initialization voltages VAINT for each pixel PXij. Referring to FIG. 2, for example, the power supply 16 may provide a first anode initialization voltage VAINT1 to the first pixel PX1 emitting light in the first color (for example, red), a second anode initialization voltage VAINT2 to the second pixel PX2 emitting light in the second color (for example, green), and a third anode initialization voltage VAINT3 to the third pixel PX3 emitting light in the third color (for example, blue). The first anode initialization voltage VAINT1, the second anode initialization voltage VAINT2, and the third anode initialization voltage VAINT3 may have different voltage levels. Referring to FIG. 3, for example, the power supply 16 may commonly provide the first anode initialization voltage VAINT1 or the second anode initialization voltage VAINT2 to the first pixel PX1 and the second pixel PX2, and provide the third anode initialization voltage VAINT3 to the third pixel PX3. For example, a same anode initialization voltage VAINT may be provided to the first pixel PX1 and the second pixel PX2, and the third initialization voltage VAINT3 different from the initialization voltage of the first pixel PX1 and the second pixel PX2 may be provided to the third pixel PX3.

According to an embodiment, the timing controller 11 and the data driver 12 may be configured as one integrated circuit. In another embodiment, the timing controller 11, the data driver 12, and the power supply 16 may be configured as one integrated circuit. In another embodiment, the timing controller 11, the data driver 12, the power supply 16, the scan driver 13, and the emission driver 15 may be configured as one integrated circuit. As described above, configuring each of component integrally or separately may be determined according to a product.

FIG. 4 is a schematic diagram of an equivalent circuit of the pixel included in the display device of FIG. 1 according to an embodiment.

Referring to FIG. 4, the pixel PXij may include a pixel circuit PXC and a light emitting element LD. The pixel circuit PXC may include transistors T1, T2, T3, T4, T5, T6, T7, and T8 and a storage capacitor Cst.

The pixel PXij may be positioned in an i-th pixel row and may be positioned in a j-th pixel column. Pixels connected to a same scan line may be defined as one pixel row, and pixels connected to a same data line may be defined as one pixel column.

The pixel PXij may be the first pixel for expressing the first color. Because the second pixel for expressing the second color and the third pixel for expressing the third color may be configured identically to the first pixel, an overlapping description is omitted.

P-type transistors may be polysilicon semiconductor transistors. In a polysilicon semiconductor transistor, a channel of an active layer may include a polysilicon semiconductor. For example, a poly silicon semiconductor transistor may be a low temperature poly-silicon (LTPS) thin film transistor. A polysilicon semiconductor transistor may have high electron mobility and thus have a fast driving characteristic.

N-type transistors may be oxide semiconductor transistors. In an oxide semiconductor transistor, a channel of an active layer may include an oxide semiconductor. For example, an oxide transistor may be a low temperature polycrystalline oxide (LTPO) thin film transistor. An oxide semiconductor transistor may have charge mobility lower than the charge mobility of the polysilicon semiconductor transistor. Therefore, an amount of leakage current generated in a turn-off state of an oxide semiconductor transistor may be less than an amount of leakage current of polysilicon semiconductor transistors.

A gate electrode of the first transistor T1 may be connected to a first node N1, a first electrode may be connected to a second node N2, and a second electrode may be connected to a third node N3. The first transistor T1 may be a driving transistor. The first transistor T1 may be a P-type transistor.

A gate electrode of the second transistor T2 may be connected to the first scan line GWi, a first electrode may be connected to the data line DLj, and a second electrode may be connected to the second node N2. The second transistor T2 may be a switching transistor. The second transistor T2 may be a P-type transistor.

The first scan driver 13GW may provide a turn-on level of first scan signal determining a time point in case that the pixel PXij receives the data voltage. For example, the second transistor T2 receiving the turn-on level of first scan signal may be turned on, and the second transistor T2 may apply the data voltage applied from the data line DLj to the second node N2.

A gate electrode of the third transistor T3 may be connected to the fourth scan line GCi, a first electrode may be connected to the first node N1, and a second electrode connected to the third node N3. The third transistor T3 may be a diode connection transistor. The third transistor T3 may be an N-type transistor.

A gate electrode of the fourth transistor T4 may be connected to the third scan line Gli, a first electrode may be connected to the first node N1, and a second electrode may receive the initialization voltage VINT. The fourth transistor T4 may be a gate initialization transistor. The fourth transistor T4 may be an N-type transistor.

A gate electrode of the fifth transistor T5 may be connected to the emission line EMi, a first electrode may receive the second power voltage ELVDD, and a second electrode may be connected to the second node N2. The fifth transistor T5 may be a first emission control transistor. The fifth transistor T5 may be a P-type transistor.

A gate electrode of the sixth transistor T6 may be connected to the emission line EMi, a first electrode connected to the third node N3, and a second electrode connected to a fourth node N4. The sixth transistor T6 may be a second emission control transistor. The sixth transistor T6 may be a P-type transistor.

A gate electrode of the seventh transistor T7 may be connected to the second scan line GBi, a first electrode may receive the anode initialization voltage VAINT, and a second electrode may be connected to the fourth node N4. The seventh transistor T7 may be an anode initialization transistor. The seventh transistor T7 may be a P-type transistor. A size of the anode initialization voltage VAINT may be different from a size of the initialization voltage VINT.

The anode initialization voltage VAINT may be set according to a type of the light emitting element LD. According to the type of the light emitting element LD, an emission start time may be different, and a color-shifting phenomenon may occur due to the difference in the emission start time. For example, referring to FIG. 2, sizes of the first anode initialization voltage VAINT1 for the light emitting element LD (or the first pixel PX1) of the first color, the second anode initialization voltage VAINT2 for the light emitting element LD (or the second pixel PX2) of the second color, and the third anode initialization voltage VAINT3 for the light emitting element LD (or the third pixel PX3) of the third color may be set differently from each other. In another embodiment, the anode initialization voltages VAINT for the light emitting elements LD of two colors may be set equally, and the anode initialization voltages VAINT for the light emitting elements LD of a remaining color may be set differently. Referring to FIG. 3, for example, the first anode initialization voltage VAINT1 for the first pixel PX1 and the second anode initialization voltage VAINT2 for the second pixel PX2 may be set equally, and the third anode initialization voltage VAINT3 for the third pixel PX3 may be set differently. In another embodiment, the anode initialization voltages VAINT for all light emitting elements LD may be set equally. Accordingly, the difference in the emission start time of the light emitting elements LD for each color may be adjusted, thereby preventing the color-shifting phenomenon.

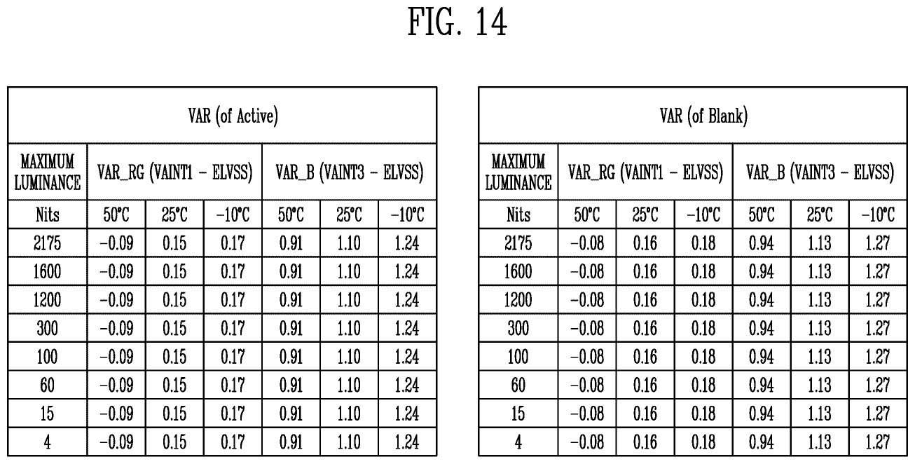

As will be described below with reference to FIGS. 14 and 17, the anode initialization voltage VAINT may change according to a maximum luminance and/or a frequency change (or refresh rate variation). In an embodiment, one of the first anode initialization voltage VAINT1, the second anode initialization voltage VAINT2, and the third anode initialization voltage VAINT3 may change differently from another ones of the first anode initialization voltage VAINT1, the second anode initialization voltage VAINT2, and the third anode initialization voltage VAINT3. Through this, a change of an emission luminance and a color change due to the maximum luminance and/or the frequency change may be minimized.

The second scan driver 13 GB may provide a turn-on level of second scan signal determining a timing for initializing an anode voltage of the light emitting element LD. For example, the seventh transistor T7 receiving the turn-on level of second scan signal may be turned on, the anode initialization voltage VAINT may be applied to an anode of the light emitting element LD, and thus the anode of the light emitting element LD may be initialized to the anode initialization voltage VAINT.

A gate electrode of the eighth transistor T8 may be connected to the second scan line GBi, a first electrode may receive a bias voltage VOBS, and a second electrode may be connected to the second node N2. The eighth transistor T8 may be a bias transistor. The eighth transistor T8 may be a P-type transistor.

A first electrode of the storage capacitor Cst may receive the second power voltage ELVDD, and a second electrode may be connected to the first node N1.

The anode of the light emitting element LD may be connected to the fourth node N4, and a cathode may receive the first power voltage ELVSS. The light emitting element LD may emit light in one of the first color, the second color, and the third color. The light emitting element LD may be a light emitting diode. The light emitting element LD may be configured of an organic light emitting diode, an inorganic light emitting diode, a quantum dot/well light emitting diode, or the like. In an embodiment, each pixel may be provided with only one light emitting element LD, but the disclosure is not limited thereto, and in another embodiment, each pixel may be provided with multiple light emitting elements. In an embodiment, the light emitting elements may be connected in series, parallel, series-parallel, or the like.

FIGS. 5 and 6 are schematic diagrams illustrating a display frequency change according to an embodiment.

The display device 10 may support a variable refresh rate (VRR). A refresh rate may be a frequency at which the data voltage is written to the pixel PXij, may be also referred to as a screen scan rate or a screen refresh rate, and may indicate the number of image frames played per second.

For example, the pixel unit 14 may display an image at a first frequency AHz in a first mode (refer to FIG. 5), and may display an image at a second frequency BHz lower than the first frequency AHz in a second mode (refer to FIG. 6).

For example, in the first mode, each frame period IF may include one address scan period AS and one self scan period SS with respect to each pixel PXij. For example, in the second mode, each frame period IF may include one address scan period AS and multiple self scan periods SS with respect to each pixel PXij. As the second frequency BHz decreases, the number of self scan periods SS included in one frame period IF may increase. In another embodiment, in a third mode, each frame period IF may include only one address scan period AS and may not include a self scan period SS with respect to each pixel PXij.

The address scan period AS may be a period for writing the data voltage to the pixel PXij. The address scan period AS may also be referred to as a data programming period for receiving the data voltage from the data line DLj.

The self scan period SS may be a period in which the data voltage is not written to the pixel PXij. During an emission period of the self scan period SS, the pixel PXij may emit light using the data voltage written in the address scan period AS. A length of the self scan period SS may be equal to a length of the address scan period AS.

FIG. 7 is a graph illustrating the address scan period.

Referring to FIGS. 4 and 7, at a time point t1a, as an emission signal of a turn-off level (a high level) may be applied to the emission line EMi, the fifth transistor T5 and the sixth transistor T6 may be turned off, and thus the pixel PXij may be in a non-emission state.

At a time point t2a, a third scan signal of a turn-on level (a high level) may be applied to the third scan line GIi, and thus the fourth transistor T4 may be turned on. Accordingly, the initialization voltage VINT may be applied to the first node N1. The initialization voltage VINT may be a sufficiently low voltage and may on-bias the first transistor T1.

At a third time point t3a, a fourth scan signal of a turn-on level (a high level) may be applied to the fourth scan line GCi, and thus the third transistor T3 may be turned on. Therefore, the first transistor T1 may be in a diode-connected state in which a drain electrode and the gate electrode are connected.

At a time point t4a, a scan signal of a turn-on level (a low level) may be applied to the first scan line GWi, and thus the second transistor T2 may be turned on. Therefore, the data voltage of the data line DLj may be applied to the first node N1 through the second transistor T2, the first transistor T1, and the third transistor T3 that are in a turn-on state, and a voltage of the first node N1 may be a compensation voltage obtained by subtracting a threshold voltage of the first transistor T1 from the data voltage. The storage capacitor Cst may maintain a voltage difference between the second power voltage ELVDD and the compensation voltage.

At a time point t5a, a second scan signal of a turn-on level (a low level) may be applied to the second scan line GBi, and thus the seventh transistor T7 and the eighth transistor T8 may be turned on. As the seventh transistor T7 is turned on, the anode initialization voltage VAINT may be applied to the anode of the light emitting element LD, and the light emitting element LD may be initialized to a charge amount corresponding to a voltage difference between the anode initialization voltage VAINT and the first power voltage ELVSS. Accordingly, a low grayscale expression of the light emitting element LD may be facilitated.

As the eighth transistor T8 is turned on, a voltage of the second node N2 may be set to the bias voltage VOBS. Accordingly, because the bias voltage VOBS is applied to a source electrode of the first transistor T1, a hysteresis phenomenon may be prevented and an on-bias state may be guaranteed.

At a time point t6a, an emission signal of a turn-on level (a low level) may be applied to the emission line EMi, and thus the fifth transistor T5 and the sixth transistor T6 may be turned on. Accordingly, a path of a driving current flowing from the second power voltage ELVDD to the first power voltage ELVSS via the fifth transistor T5, the first transistor T1, the sixth transistor T6, and the light emitting element LD may be formed.

A driving current amount may be adjusted according to a voltage maintained in the storage capacitor Cst. The light emitting element LD may emit light with a luminance corresponding to the driving current amount. The light emitting element LD may emit light until an emission signal of a turn-off level is applied to the emission line EMi.

FIG. 8 is a graph illustrating the self scan period.

Referring to FIGS. 4 and 8, at a time point t7a, as an emission signal of a turn-off level (a high level) is applied to the emission line EMi, the fifth transistor T5 and the sixth transistor T6 may be turned off, and thus the pixel PXij may be in the non-emission state.

During a period t7a to t8a, scan signals of a turn-off level may be maintained in the first scan line GWi, the third scan line Gli, and the fourth scan line GCi. Therefore, the voltage of the first node N1 may not change.

At a time point t8a, a scan signal of a turn-on level (a low level) may be applied to the second scan line GBi, and the seventh transistor T7 and the eighth transistor T8 may be turned on. As the seventh transistor T7 is turned on, the anode initialization voltage VAINT may be applied to the anode of the light emitting element LD, and the light emitting element LD may be initialized with a charge amount corresponding to a voltage difference between the anode initialization voltage VAINT and the first power voltage ELVSS. Accordingly, low grayscale expression of the light emitting element LD may be facilitated.

As the eighth transistor T8 is turned on, the voltage of the second node N2 may be set to the bias voltage VOBS. Accordingly, because the bias voltage VOBS is applied to the source electrode of the first transistor T1, the hysteresis phenomenon may be prevented and the on-bias state may be guaranteed.

At a time point t9a, an emission signal of a turn-on level (low level) may be applied to the emission line EMi, and thus the fifth transistor T5 and the sixth transistor T6 may be turned on. Therefore, a path of a driving current flowing from the second power voltage ELVDD to the first power voltage ELVSS through the fifth transistor T5, the first transistor T1, the sixth transistor T6, and the light emitting element LD may be formed.

The driving current amount may be controlled according to the voltage maintained in the storage capacitor Cst. Because the voltage of the first node N1 recorded during the address scan period AS is maintained during the self scan period SS, a luminance of the pixel PXij in the self scan period SS may be equal to the luminance of the pixel PXij in the address scan period AS.

FIG. 9 is a schematic diagram illustrating a voltage setting device according to an embodiment.

Referring to FIG. 9, the voltage setting device ED may include a luminance measurement unit 110 and an inspection control unit 120. The inspection control unit 120 may be configured as a general-purpose or dedicated computing device. The computing device may include a recording medium and a processor. The recording medium and the processor may be included in a physically same device, or may be included in physically different devices using cloud technology or the like. The luminance measurement unit 110 may be configured of a camera or a luminance meter.

The recording medium may include a type of recording devices that may store data or programs that may be read by the processor. An example of the recording medium that may be read by the processor may include a ROM, a RAM, a CD-ROM, a magnetic tape, a floppy disk, an optical data storage device, a hard disk, an external hard disk, an SSD, a USB storage device, a DVD, Blu-ray disk, and the like. The recording medium that may be read by the processor may be a combination of multiple devices, and may be distributed in a computer system connected through a network. Such a recording medium may be a non-transitory recording medium. The non-transitory recording medium may be a medium that stores data or a program semi-permanently and is readable by the processor, rather than a medium that stores data or a program during a short period of time, such as a register, a cache, or a memory.

The inspection control unit 120 may provide test voltages to the display device 10 or control the display device 10 to generate the test voltages. The luminance measurement unit 110 may capture an image displayed by the display device 10 or measure a luminance based on the test voltages.

The inspection control unit 120 may set test voltages determined to be suitable for the display device 10 as voltage values of the display device 10. The set voltage values may be stored in a memory of the display device 10.

FIG. 10 is a flowchart illustrating a voltage setting method according to embodiments. FIGS. 11 to 14 are tables illustrating the voltage setting method of FIG. 10.

Referring to FIGS. 1, 9, and 10 to 14, the voltage setting method may be performed by the voltage setting device ED of FIG. 9.

The display device 10 may display an image based on a maximum luminance selected from among maximum luminances (4 nits to 2175 nits). As described above, the maximum luminance may be manually set by a user's operation of the display device 10, or may be automatically set by an algorithm linked to an illuminance sensor or the like. Even for a same grayscale, because the data voltage varies according to the maximum luminance, an emission luminance of the pixel may also vary.

However, in case that various voltages are tested one by one with respect to all maximum luminances (4 nits to 2175 nits), an excessively long tact time may be required, and thus an efficient voltage setting method is required.

First, the voltage setting device ED or the display device 10 may set emission duty ratios with respect to the maximum luminances (4 nits to 2175 nits). Such an emission duty ratio may not be tested by the voltage setting device ED, but may be stored in the memory of the display device 10 as a preset (or predetermined) value.

The emission duty ratio may be a ratio of a period in which each pixel PXij emits light during one frame period. For example, in case that the pixel PXij emits light during 80% of one frame period, the emission duty ratio may be 80%. For example, in case that the pixel PXij emits light during 5% of one frame period, the emission duty ratio may be 5%. Referring to FIG. 7, in case that an emission signal applied to the emission line EMi is a low level, the fifth transistor T5 and the sixth transistor T6 may be turned on, and a driving current may be supplied to the light emitting element LD. Therefore, in a case of the display device 10 including the pixel PXij of FIG. 4, a ratio of a period in which the emission signal is the low level during one frame period may be the emission duty ratio.

For maximum luminances in a range of, for example, 4 nits to 100 nits, the emission duty ratio (8.9% to 89%) may be set small as the maximum luminance is low. Therefore, in a case of the maximum luminances (4 nits to 100 nits), even though a difference of the second power voltage ELVDD and the first power voltage ELVSS is the same, a luminance of the display device 10 may be controlled using the emission duty ratio. A same emission duty ratio (8.9%) may be set for adjacent maximum luminances (for example, 4 nits and 10 nits). For maximum luminances in a range of, for example, 100 nits to 2175 nits, a same emission duty ratio (for example, 89%) may be set. The same emission duty ratio may be a maximum value (89%) among set emission duty ratios (8.9% to 89%).

The voltage setting device ED may set the first power voltages ELVSS for the maximum luminances (4 nits to 2175 nits), based on a first maximum luminance ML1 (S100). For example, the first maximum luminance ML1 may be determined in advance as a maximum luminance (for example, 650 nits) most frequently used by a user of the display device 10.

For example, the inspection control unit 120 may control the display device 10 so that the display device 10 displays a white image. For example, the inspection control unit 120 may change the first power voltage ELVSS so that a luminance measured by the luminance measurement unit 110 becomes 650 nits.

Even though the display devices 10 are display devices 10 of a same model, a size of the first power voltage ELVSS required to express the first maximum luminance ML1 may be different according to a process deviation. For example, a process deviation may exist according to a position of a mother substrate, and even though the display devices 10 are the display devices 10 of a same model, the size of the first power voltage ELVSS required to express the first maximum luminance ML1 may be different. Therefore, the first power voltage ELVSS may be set to a range (a minimum value to a maximum value) that may satisfy all of display devices 10 with respect to the first maximum luminance ML1. The minimum value and the maximum value may be based on an absolute value of a numerical value. In each of the display devices 10, the first power voltage ELVSS for the first maximum luminance ML1 may be individually set in the set range.

The voltage setting device ED may not perform an additional test with respect to other maximum luminances (4 nits to 300 nits and 1200 nits to 2175 nits) other than the first maximum luminance ML1. The voltage setting device ED may determine the first power voltages ELVSS for other maximum luminances (4 nits to 300 nits and 1200 nits to 2175 nits) by adding or subtracting an offset value to or from the first power voltage ELVSS determined with respect to the first maximum luminance ML1.

For example, with respect to the maximum luminances (100 nits to 2175 nits), the greater the maximum luminance, the higher the first power voltage ELVSS may be set. The size of the first power voltage ELVSS may be based on an absolute value. Therefore, in a case of the maximum luminances (100 nits to 2175 nits), even though the emission duty ratio is the same, the luminance of the display device 10 may be adjusted using a difference of the second power voltage ELVDD and the first power voltage ELVSS. A same first power voltage ELVSS may be set at some adjacent maximum luminances (for example, 1600 nits and 2175 nits).

With respect to the maximum luminances (4 nits to 100 nits), a same first power voltage ELVSS may be set.

The voltage setting device ED may set black data voltages for the maximum luminances (4 nits to 2175 nits) based on a second maximum luminance ML2 (S200). The first maximum luminance ML1 and the second maximum luminance ML2 may be different from each other. For example, the second maximum luminance ML2 may be greater than the first maximum luminance ML1. At the brightest maximum luminance (2175 nits) among the maximum luminances (4 nits to 2175 nits), black image expression may be the most vulnerable (e.g., black lifting may occur). Therefore, it may be desirable that the second maximum luminance ML2 is set to the maximum luminance (2175 nits).

The voltage setting device ED may set a black data voltage for the second maximum luminance ML2 to display a black image by repeatedly testing temporary black data voltages (for example, 4.8 V to 6.2 V). For example, the voltage setting device ED may check whether a luminance of a black image becomes below a reference value while gradually increasing the temporary black data voltage from 4.8 V. In case that the luminance of the black image becomes equal to or less than a reference value, the voltage setting device ED may determine the corresponding temporary black data voltage as a black data voltage for the second maximum luminance ML2. Because a luminance measurement time of the luminance measurement unit 110 decreases as a brightness of a display image is increased, it may be advantageous to test the temporary black data voltage by gradually increasing the temporary black data voltage from a minimum value to a maximum value.

The voltage setting device ED may set the black data voltages for the remaining maximum luminances (4 nits to 1600 nits) by applying offsets based on the black data voltage for the second maximum luminance ML2. Applying the offsets to the black data voltage for the second maximum luminance ML2 may mean adding the offsets to the black data voltage for the second maximum luminance ML2. The offsets may have a value equal to or less than 0. For example, in case that the black data voltage of the first color for the second maximum luminance ML2 is set to 6.0 volts, the black data voltage of the first color for the maximum luminance 30 nits may be set to 5.962 volts. For example, the smaller the maximum luminance, the lower the black data voltage may be set.

The voltage setting device ED may set difference values VAR_RG and VAR_B of the anode initialization voltages VAINT and the first power voltages ELVSS. The anode initialization voltage VAINT may be higher than the first power voltage ELVSS, and thus the difference values VAR_RG and VAR_B may be a positive number. As the difference value of the anode initialization voltage VAINT and the first power voltage ELVSS is decreased, low grayscale may be more readily expressed.

In an embodiment, the voltage setting device ED may set the difference values VAR_RG and VAR_B so that the luminance change according to the frequency change is minimized (S300). The difference value VAR_RG may be a difference between the first anode initialization voltage VAINT1 (or the second anode initialization voltage VAINT2) of FIG. 3 and the first power voltage ELVSS, and the difference value VAR_B may be a difference between the third anode initialization voltage VAINT3 and the first power voltage ELVSS. The voltage setting device ED may set the difference values VAR_RG and VAR_B based on at least one of the maximum luminances (4 nits to 2175 nits).

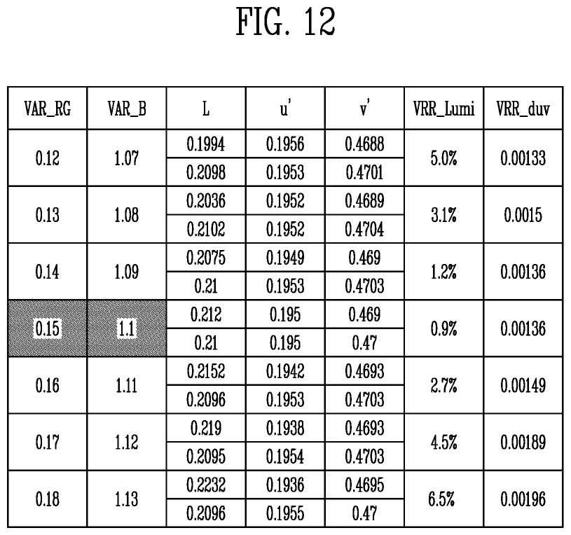

For example, the voltage setting device ED may set the difference values VAR_RG and VAR_B to display the black image by repeatedly testing temporary difference values. Referring to FIG. 12, for example, a range of a difference value VAR_RG (or a temporary difference value) for the first color and the second color may be in a range of 0.12 volts to 0.18 volts. A range of the difference value VAR_B for the third color may be in a range of 1.07 volts to 1.13 volts. Pairs of the difference values VAR_RG and VAR_B (or the temporary difference values) may be preset. For example, in case that the difference value VAR_RG (or the temporary difference value) is 0.12 volts, the difference value VAR_B (or the temporary difference value) may be set to 1.07 volts. For example, in case that the difference value VAR_RG (or the temporary difference value) is 0.18 volts, the difference value VAR_B (or the temporary difference value) may be set to 1.13 volts. The difference values VAR_RG and VAR_B (or the temporary difference values) may be set to be proportional to each other, but the disclosure is not limited thereto.

In an embodiment, the voltage setting device ED may determine temporary difference values at which the luminance change according to the frequency change is minimized as the difference values VAR_RG and VAR_B while gradually changing the temporary difference values. As the pairs of the temporary difference values (or the difference values VAR_RG and VAR_B) are preset, the voltage setting device ED may simultaneously vary the temporary difference value for the first color and the second color and the temporary difference value for the third color. Because an excessively long tact time is required to test all combinations of the temporary difference values, pairs of preset temporary difference values may be used.

In an embodiment, the voltage setting device ED may measure a luminance of an image displayed at a first frequency, measure a luminance of an image displayed at a second frequency, and determine the temporary difference values at which a difference between a measurement luminance according to the first frequency and a measurement luminance according to the second frequency is minimized as the difference values VAR_RG and VAR_B.

For example, the first frequency may be 120 Hz, and the second frequency may be 10 Hz, but the disclosure is not limited thereto. For example, in case that the difference value VAR_RG (or the temporary difference value) is 0.12 volts and the difference value VAR_B (or the temporary difference value) is 1.07 volts, the luminance L according to the first frequency may be 0.1994, and the luminance L according to the second frequency may be 0.2098. A luminance change rate VRR_Lumi may be about 5%. For example, in case that the difference value VAR_RG (or the temporary difference value) is 0.15 V and the difference value VAR_B (or the temporary difference value) is 1.1 V, the luminance L according to the first frequency may be 0.212, and the luminance L according to the second frequency may be 0.21. The luminance change rate VRR_Lumi may be about 0.9%, and may be the smallest among luminance change rates of the temporary difference values. Because the luminance L and the luminance change rate VRR_Lumi for the remaining difference values VAR_RG and VAR_B are as shown in FIG. 12, a description thereof is omitted. The voltage setting device ED may determine the difference value VAR_RG as 0.15 volts and the difference value VAR_B as 1.1 volts, at which the luminance change is minimized.

In case that the difference value VAR_RG (or the temporary difference value) is 0.12 volts and the difference value VAR_B (or the temporary difference value) is 1.07 volts, a color difference (u′, v′) (or a color coordinate) according to the first frequency may be “0.1956, 0.4688”, a color difference (u′, v′) according to the second frequency may be “0.1953, 0.4701”, and a color change VRR_duv (or a color change value) may be about 0.00133. The color change VRR_duv may be calculated by Formula 1 below.

$$VRR\_duv = \sqrt{{( u 1 - u 2 )}^{2} + {( v 1 - v 2 )}^{2}} \qquad [ Formula 1 ]$$

In Formula 1, u1 and v1 may be color differences (u′, v′) according to the first frequency, and u2 and v2 may be color differences (u′, v′) according to the second frequency.

The color change VRR_duv for the remaining difference values VAR_RG and VAR_B may be as shown in FIG. 12, and it may be seen that the color change does not change or decrease significantly even though the temporary difference values (or the difference values VAR_RG and VAR_B) are changed. This is because the pairs of difference values are preset so that the color change VRR_duv becomes equal to or less than a certain level.

In an embodiment, the voltage setting device ED may set (or reset) the difference value VAR_B so that a color change according to a frequency change is minimized (S400).

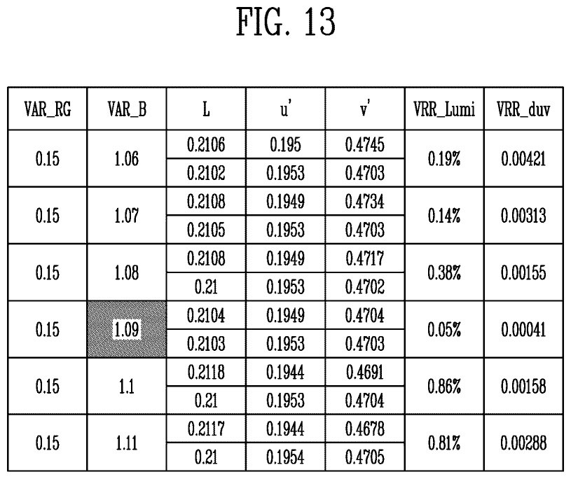

For example, the voltage setting device ED may set the difference value VAR_B by repeatedly testing the temporary difference values for the third color (or the third pixel PX3) in a state in which the difference value VAR_RG set in step S300 is fixed. Referring to FIG. 13, for example, the difference value VAR_RG for the first color and the second color may be fixed to 0.15 volts. A range of the difference value VAR_B (or the temporary difference value) for the third color may be set based on 1.09 volts, and for example, the range of the difference value VAR_B (or the temporary difference value) for the third color may be in a range of 1.06 volts to 1.11 volts. As shown in FIG. 13, the luminance change rate VRR_Lumi by the difference value VAR_B may be less than or equal to about 0.86%. For example, because the difference value VAR_RG is dominant in a luminance, the difference value VAR_RG may be fixed in setting the difference values VAR_RG and VAR_B so that the color change is minimized.

In an embodiment, the temporary difference value at which the color change according to the frequency change is minimized may be determined as the difference value VAR_B while gradually changing the temporary difference value for the third color.

In an embodiment, the voltage setting device ED may measure the luminance of the image displayed at the first frequency, measure the luminance of the image displayed at the second frequency, and determine the temporary difference value at which a difference between a color difference measured according to the first frequency and a color difference measured according to the second frequency is minimized as the difference value VAR_B.

For example, the first frequency may be 120 Hz and the second frequency may be 10 Hz, but the disclosure is not limited thereto. For example, in case that the difference value VAR_RG is 0.15 volts and the difference value VAR_B (or the temporary difference value) is 1.06 volts, the color difference (u′, v′) according to the first frequency may be “0.195, 0.4745”, and the color difference (u′, v′) according to the second frequency may be “0.1953, 0.4703”. The color change VRR_duv may be about 0.00421 according to Formula 1. For example, in case that the difference value VAR_RG is 0.15 volts and the difference value VAR_B (or the temporary difference value) is 1.09 volts, the color difference (u′, v′) according to the first frequency may be “0.1949, 0.4704”, and the color difference (u′, v′) according to the second frequency may be “0.1953, 0.4703”. The color change VRR_duv may be about 0.00041 according to Formula 1, and may be the smallest among the color changes of the temporary difference values. Because the color change VRR_duv for the remaining difference value VAR_B is as shown in FIG. 12, a description thereof is omitted. The voltage setting device ED may determine the difference value VAR_B at which the color change VRR_duv is minimized as 1.09 volts.

The difference values VAR_RG and VAR_B set to minimize the luminance change and the color change according to the frequency change may be stored in the display device 10 (or the memory of the display device 10) as a set value in the blank period. The blank period may correspond to the self scan period SS of FIGS. 5 and 6. For example, in the blank period, the pixel PXij of FIG. 4 may emit light without data writing. Accordingly, in the blank period, the emission driver 15 may provide an emission signal having a pulse of a turn-off level to the emission line EMi, and the scan driver 13 may provide a scan signal having a pulse of a turn-on level only to the second scan line GBi, and may maintain scan signals of the first, third, and fourth scan lines GWi, Gli, and GCi as a turn-off level. An active period may correspond to the address scan period AS of FIGS. 3 and 4. For example, in the active period, the pixel PXij of FIG. 4 may emit light by writing a data signal. To this end, in the active period, the emission driver 15 may provide an emission signal having a pulse of a turn-off level to the emission line EMi, and the scan driver 13 may provide scan signals having a pulse of a turn-on level to the first, second, third, and fourth scan lines GWi, GBi, Gli, and GCi.

Referring to FIG. 14, the memory of the display device 10 may store the difference values VAR_RG and VAR_B (or the difference value VAR) in the active period and the difference values VAR_RG and VAR_B in the blank period.

The difference value VAR (or the difference values VAR_RG and VAR_B) in the active period may be preset. The difference values VAR_RG and VAR_B in the active period may be stored in the memory of the display device 10 as preset (or predetermined) values. However, the disclosure is not limited thereto. For example, the difference values VAR_RG and VAR_B in the active period may be determined through a test (for example, checking whether the luminance of the black image is equal to or less a reference value while driving the display device 10 at a maximum frequency).

The difference values VAR_RG and VAR_B may be set for each driving condition (for example, a maximum luminance or a temperature). The difference values VAR_RG and VAR_B for each driving condition may be set by applying offsets to the difference values VAR_RG and VAR_B set in a specific condition. Because the difference values VAR_RG and VAR_B for each driving condition are as shown in FIG. 14, a description thereof is omitted. The difference values VAR_RG and VAR_B may be set equally for each driving condition, but the disclosure is not limited thereto. For example, the difference values VAR_RG and VAR_B may be set differently for each driving condition.

For example, based on a maximum luminance of 100 nits and a temperature of 25° C., in the active period, the difference value VAR_RG may be 0.15 volts, and the difference value VAR_B may be 1.10 volts. For example, in case that the first power voltage ELVSS is-2.2 volts, the first anode initialization voltage VAINT1 or the second anode initialization voltage VAINT2 of FIG. 3 may be −2.05 volts, and the third anode initialization voltage VAINT3 may be −1.10 volts.

For example, based on the maximum luminance of 100 nits and the temperature of 25° C. in the blank period, the difference value VAR_RG may be 0.16 volts, and the difference value VAR_B may be 1.13 volts. For example, in case that the first power voltage ELVSS is-2.2 volts, the first anode initialization voltage VAINT1 or the second anode initialization voltage VAINT2 of FIG. 3 may be −2.04 volts, and the third anode initialization voltage VAINT3 may be −1.07 volts.

Between the active period and the blank period, a change of the difference value VAR_RG (or a change of the first anode initialization voltage VAINT1 or the second anode initialization voltage VAINT2) may be 0.1 volts, and a change of the difference value VAR_B (or the third anode initialization voltage VAINT3) may be 0.13 volts. For example, between the active period and the blank period, a change amount of the difference values VAR_RG and VAR_B may be different from each other. This is because the difference value VAR_B for the blank period is additionally set (or individually set) so that the color change according to the frequency change is minimized. Accordingly, not only the luminance change according to the frequency change but also the color change may be minimized, and display quality of the display device 10 may be improved.

FIG. 15 shows graphs illustrating the color change of display devices.

Referring to FIGS. 12 to 15, a first case CASEL shows a distribution of the color change VRR_duv of display devices according to a comparative example operating based on the difference values VAR_RG and VAR_B set according to the embodiment of FIG. 12. A second case CASE2 shows a distribution of the color change VRR_duv of display devices 10 (refer to FIG. 1) according to embodiments of the disclosure operating based on the difference values VAR_RG and VAR_B set according to the embodiment of FIG. 13.

It may be seen that as shown in FIG. 15, compared to the first case CASE1, an overall size of the color change VRR_duv of the second case CASE2 is reduced, and a deviation of the color change VRR_duv is reduced.

FIGS. 16 and 17 are tables illustrating a voltage setting method according to an embodiment.

Referring to FIGS. 1, 2, 9, 10, 16, and 17, the voltage setting method may be performed by the voltage setting device ED of FIG. 9 for the display device 10 including the pixel unit 14 of FIG. 2.

The voltage setting device ED may set the difference values VAR_RG and VAR_B so that the luminance change according to the frequency change is minimized (S300).

In an embodiment, the voltage setting device ED may set the difference values VAR_RG and VAR_B to display a black image by repeatedly testing the temporary difference values. For example, a range of the difference values VAR_RG (or the temporary difference value) for the first color and the second color may be in a range of 0.24 V to 0.29 V. A range of the difference value VAR_B for the third color may be in a range of 1.19 volts to 1.24 volts. The pairs of the difference values VAR_RG and VAR_B (or the temporary difference values) may be preset.

In an embodiment, the voltage setting device ED may determine the temporary difference values at which the luminance change according to the frequency change is minimized as the difference values VAR_RG and VAR_B by gradually changing the temporary difference values.

For example, in case that the difference value VAR_RG (or the temporary difference value) is 0.28 volts and the difference value VAR_B (or the temporary difference value) is 1.23 volts, the luminance change rate VRR_Lumi may be about 0.39%, and may be the smallest among the luminance change rates of the temporary difference values. Because the luminance L and the luminance change rate VRR_Lumi for the difference values VAR_RG and VAR_B are as shown in FIG. 16, a description thereof is omitted. The voltage setting device ED may determine the difference value VAR_RG as 0.28 V and the difference value VAR_B as 1.23 V, at which the luminance change is minimized.

The voltage setting device ED may set (or reset) the difference value VAR_B so that the color change according to the frequency change is minimized (S400).

In an embodiment, the voltage setting device ED may set the difference value VAR_B by repeatedly testing the temporary difference values for the third color (or the third pixel PX3) in a state in which the difference value VAR_RG set in step S300 is fixed. For example, the difference value VAR_RG for the first color and the second color may be fixed to 0.28 volts. A range of the difference value VAR_B (or the temporary difference value) for the third color may be in a range of 1.16 volts to 1.21 volts.

In an embodiment, the temporary difference value at which the color change according to the frequency change is minimized may be determined as the difference value VAR_B by gradually changing the temporary difference value for the third color.

For example, in case that the difference value VAR_RG is 0.28 volts and the difference value VAR_B (or the temporary difference value) is 1.19 volts, the color change VRR_duv may be about 0.0005, and may be the smallest among the color changes of the temporary difference values. Because the color change VRR_duv for the remaining difference values VAR_B is as shown in FIG. 16, a description thereof is omitted. The voltage setting device ED may determine the difference value VAR_B at which the color change VRR_duv is minimized as 1.19 volts.

The voltage setting device ED may set (or reset) the difference value VAR_R so that the color change according to the frequency change is minimized.

In an embodiment, the voltage setting device ED may set the difference value VAR_R by repeatedly testing the temporary difference values for the first color (or the first pixel PX1) in a state in which the difference value VAR_RG set in step S300 is fixed as the difference value VAR_G and the difference value VAR_B set in step S400 is fixed. For example, the difference value VAR_G for the second color may be fixed to 0.28 volts, and the difference value VAR_B for the third color may be fixed to 1.19 volts. A range of the difference value VAR_R (or the temporary difference value) for the first color may be in a range of 0.23 volts to 0.28 volts.

In an embodiment, the temporary difference value at which the color change according to the frequency change is minimized may be determined as the difference value VAR_R while gradually changing the temporary difference value for the first color.

For example, in case that the difference value VAR_G is 0.28 volts, the difference value VAR_B is 1.19 volts, and the difference value VAR_R (or the temporary difference value) is 0.26 volts, the color change VRR_duv may be about 0.0000, and may be the smallest among the color changes of the temporary difference values. Because the color change VRR_duv for the remaining difference values VAR_R is as shown in FIG. 16, a description thereof is omitted. The voltage setting device ED may determine the difference value VAR_R at which the color change VRR_duv is minimized as 0.26 volts.

Blue may affect the color differences u′ and v′, and red may affect the color difference v′. Therefore, the color change VRR_duv may be set to be equal to or less than a reference value through a process of resetting the difference value VAR_B, and the color change VRR_duv may be finely adjusted to be minimized through a process of resetting the difference value VAR_R.

Referring to FIG. 17, the memory of the display device 10 may store the difference values VAR_R, VAR_G, and VAR_B (or the difference value VAR) in the active period and the difference values VAR_R, VAR_G, and VAR_B in the blank period.

Through the embodiment of FIG. 16, the difference value VAR_R in the blank period may be set to 0.26 volts, the difference value VAR_G may be set to 0.28 volts, and the difference value VAR_B may be set to 1.19 volts, respectively. The difference value VAR_R in the active period may be set to 0.25 volts, the difference value VAR_G may be set to 0.25 volts, and the difference value VAR_B may be set to 1.2 volts, respectively. The difference values VAR_R, VAR_G, and VAR_B shown in FIG. 16 may be values set in a specific driving condition (for example, a maximum luminance or a temperature), and as described with reference to FIG. 14, the difference values VAR_R, VAR_G, and VAR_B may be set equally or differently for each driving condition.

Between the active period and the blank period, a change amount of the difference value VAR_R (or a change amount of the first anode initialization voltage VAINT1) may be 0.01 volts, a change amount of the difference value VAR_G (or a change amount of the second anode initialization voltage VAINT2) may be 0.03 volts, and a change amount of the difference value VAR_B (or a change amount of the third anode initialization voltage VAINT3) may be −0.01 volts. For example, a change amount of the differences VAR_R, VAR_G, and VAR_B between the active period and the blank period may be different from each other. This is because the difference values VAR_B and VAR_R for the blank period are additionally set (or individually set) so that the color change according to the frequency change is minimized. Accordingly, not only the luminance change according to the frequency change but also the color change may be minimized, and display quality of the display device 10 may be improved.

A display device according to an embodiment may be applicable to various types of electronic devices. In an embodiment, an electronic device may include the above-described display device and may further include other modules or devices having additional functions in addition to the display device.

FIG. 18 is a schematic block diagram of an electronic device according to an embodiment. Referring to FIG. 18, the electronic device 10 may include a display module 11 (or a display device), a processor 12, a memory 13, and a power module 14.

The processor 12 may include at least one of a central processing unit (CPU), an application processor (AP), a graphic processing unit (GPU), a communication processor (CP), an image signal processor (ISP), and a controller. The processor 12 may provide input image data (e.g., grayscales for an input image) to the display module and change a frequency or a refresh rate of an image.

The memory 13 may store data and/or information used to operate the processor 12 or the display module 11. In case that the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module may convert power supplied by the power supply module and generate power to operate the electronic device 10.

At least one of the above-described components of the electronic device 10 may be included in the display device according to embodiments as described above. In terms of functionality, some of the individual modules included in one module may be included in the display device and others may be provided separately from the display device. For example, the display module 11 may be included in the display device, whereas the processor 12, the memory 13, and the power module 14 may not be included in the display device and instead be provided separately in the electronic device 10.

FIG. 19 shows schematic diagrams of various embodiments of an electronic device.

Referring to FIG. 19, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

The above description is an example of technical features of the disclosure, and those skilled in the art to which the disclosure pertains will be able to make various modifications and variations. Therefore, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. A voltage setting method of a display device in the display device including pixels, the voltage setting method comprising:
setting a first power voltage provided to a cathode of a light emitting element of each of the pixels;
setting a difference value between an anode initialization voltage provided to an anode of the light emitting element and the first power voltage so that a luminance change according to a frequency change is minimized; and
resetting the difference value so that a color change according to the frequency change is minimized.

2. The voltage setting method according to claim 1, wherein
the pixels include a first pixel, a second pixel, and a third pixel that emit light with different colors, and
the setting of the difference value comprises setting a second difference value for the first pixel and the second pixel and a third difference value for the third pixel by repeatedly testing temporary difference values for the first to third pixels.

3. The voltage setting method according to claim 2, wherein the first pixel emits light in red, the second pixel emits light in green, and the third pixel emits light in blue.

4. The voltage setting method according to claim 2, wherein in the repeatedly testing of the temporary difference values for the first to third pixels, the temporary difference values for the first and second pixels and the temporary difference values for the third pixel simultaneously changes.

5. The voltage setting method according to claim 2, wherein the setting of the difference value further comprises:
measuring a luminance of an image displayed at a first frequency;
measuring a luminance of an image displayed at a second frequency; and
determining the second and third difference values at which a difference between a measurement luminance at the first frequency and a measurement luminance at the second frequency is minimized.

6. The voltage setting method according to claim 2, wherein the resetting of the difference value comprises resetting the third difference value by repeatedly testing the temporary difference values for the third pixel in a state in which the second difference value is fixed.

7. The voltage setting method according to claim 6, wherein the resetting of the difference value further comprises:
measuring a color coordinate of an image displayed at a first frequency;
measuring a color coordinate of an image displayed at a second frequency; and
determining the third difference value at which a difference between a color difference measured at the first frequency and a color difference measured at the second frequency is minimized.

8. The voltage setting method according to claim 6, wherein
a second anode initialization voltage is commonly provided as the anode initialization voltage to the first pixel and the second pixel, and
a third anode initialization voltage independent of the second anode initialization voltage is provided as the anode initialization voltage to the third pixel.

9. The voltage setting method according to claim 6, wherein the resetting of the difference value further comprises setting a first difference value for the first pixel by repeatedly testing temporary difference values for the first pixel in a state in which the second difference value and the third difference value are fixed.

10. The voltage setting method according to claim 9, wherein the anode initialization voltage provided to each of the first pixel, the second pixel, and the third pixel are different.

11. A display device comprising:
a display panel including pixels, each of the pixels including a light emitting element, and the pixels including a first pixel, a second pixel, and a third pixel that emit light with different colors;
a data driver that provides a data signal to the pixels; and
a power supply that provides an anode initialization voltage to an anode of the light emitting element and provides a first power voltage to a cathode of the light emitting element, wherein
a frame includes an active period in which the data signal is written to the pixels to emit light, and a blank period in which the pixels emit light without writing the data signal,
the anode initialization voltage in the blank period and the anode initialization voltage in the active period are different from each other, and
a change amount of the anode initialization voltage for the second pixel between the active period and the blank period and a change amount of the anode initialization voltage for the third pixel are different from each other.

12. The display device according to claim 11, wherein a change amount of the anode initialization voltage for the first pixel between the active period and the blank period and the change amount of the anode initialization voltage for the second pixel between the active period and the blank period are equal.

13. The display device according to claim 12, wherein
a second anode initialization voltage is commonly provided as the anode initialization voltage to the first pixel and the second pixel, and
a third anode initialization voltage independent of the second anode initialization voltage is provided as the anode initialization voltage to the third pixel.

14. The display device according to claim 13, wherein the first pixel emits light in red, the second pixel emits light in green, and the third pixel emits light in blue.

15. The display device according to claim 11, wherein a change amount of the anode initialization voltage for the first pixel is different from the change amount of the anode initialization voltage for the second pixel and the change amount of the anode initialization voltage for the third pixel.

16. The display device according to claim 15, wherein the anode initialization voltage provided to each of the first pixel, the second pixel, and the third pixel are different.

17. The display device according to claim 11, wherein
a difference value between the anode initialization voltage and the first power voltage in the blank period and a difference value between the anode initialization voltage and the first power voltage in the active period are different from each other, and
a difference value between the anode initialization voltage and the first power voltage for the second pixel between the active period and the blank period and a difference value between the anode initialization voltage and the first power voltage for the third pixel between the active period and the blank period are different from each other.

18. The display device according to claim 17, wherein a difference value between the anode initialization voltage and the first power voltage for the first pixel between the active period and the blank period and the difference value between the anode initialization voltage and the first power voltage for the second pixel between the active period and the blank period are equal.

19. The display device according to claim 17, wherein a difference value between the anode initialization voltage and the first power voltage for the first pixel between the active period and the blank period is different from the difference value for the second pixel and the difference value for the third pixel.

20. An electronic device comprising:
a display panel including pixels, each of the pixels including a light emitting element, and the pixels including a first pixel, a second pixel, and a third pixel that emit light with different colors;
a data driver that provides a data signal to the pixels based on input image data;
a processor that provides the input image data to the data driver; and
a power supply that provides an anode initialization voltage to an anode of the light emitting element and a first power voltage to a cathode of the light emitting element, wherein
the anode initialization voltage changes according to a refresh rate, and
in case that the refresh rate changes, a change amount of the anode initialization voltage for the second pixel and a change amount of the anode initialization voltage for the third pixel are different from each other.
